(19) United States
(12) Patent Application Publication
(10) Pub. No.: US 2010/0087603 A1
(43) Pub. Date: Apr. 8, 2010

(54) ORGANIC-INORGANIC HYBRID NANOMATERIALS AND METHOD FOR SYNTHESIZING SAME

(75) Inventors: William J. Brittain, Aurora, OH (US); Bindushree Radhakrishnan, Stow, OH (US); Rajesh Ranjan, Mayfield Heights, OH (US)

Correspondence Address: Joseph J. Crimaldi;Roetzel & Andress, 222 S. Main St., Akron, OH, 44308, US

(73) Assignee: THE UNIVERSITY OF AKRON, Akron, OH (US)

(21) Appl. No.: 12/446,761

(22) PCT Filed: Oct. 26, 2007
(86) PCT No.: PCT/US07/22761

§ 371 Date: Nov. 10, 2009

Related U.S. Application Data
(60) Provisional application No. 60/854,873, filed on Oct. 27, 2006.

(51) Int. Cl. C08F 8/00

(52) U.S. Cl. 525/342

(57) ABSTRACT

Organic-inorganic hybrid nanomaterials, comprising an inorganic portion (e.g., inorganic particles such as silica particles) that are coated/covered with one or more polymers compounds (i.e., the organic portion), and methods for synthesizing such hybrid nanomaterials are disclosed. Also disclosed are hybrid nanomaterials that comprise an inorganic portion (e.g., inorganic particles such as silica particles) that have one or more polymers or polymer portions (i.e., the organic portion) grafted and/or attached thereto, and methods for synthesizing such hybrid nanomaterials.

### FIELD OF THE INVENTION

The present invention relates to organic-inorganic hybrid nanomaterials, and to methods for synthesizing same. In one embodiment, the present invention relates to hybrid nanomaterials that comprise an inorganic portion (e.g., inorganic particles such as silica particles) that are coated/covered with one or more polymers compounds (i.e., the organic portion), and to methods for synthesizing such hybrid nanomaterials. In another embodiment, the present invention relates to hybrid nanomaterials that comprise an inorganic portion (e.g., inorganic particles such as silica particles) that have one or more polymers or polymer portions (i.e., the organic portion) grafted and/or attached thereto, and to methods for synthesizing such hybrid nanomaterials.

### BACKGROUND OF THE INVENTION

Silica nanoparticles, find applications based on porosity and hardness. However one challenge in producing such nanoparticles is to control the interparticle aggregation. One way to avoid aggregation is to covalently graft polymer chains on the particle. The chemical modification of silica nanoparticle surface with a polymer not only improves the stability but can also alter the mechanical, structural and thermal properties of particle and the polymer. Such hybrid organic-inorganic materials find a number of applications, including a variety of applications in the fields of optics and electronics (see, e.g., Mark, J. E. and Lee, C.; Hybrid Inorganic-Organic Composites; American Chemical Society: Washington, D.C.; Vol. 585; 1995).

Both “grafting-to” and “grafting-from” methods have been explored for the synthesis of hybrid nanomaterials from preformed silica nanoparticles. The “grafting-to” technique involves the chemical absorption of a reactive polymer end group to the surface (see, e.g., Aury, P., Auray, L., and Leger, L; J. Coll. Interf. Sci.; 1992; Vol. 150; p. 187). However the grafting density, which holds the key to the final properties of the hybrid nanomaterial, is low due to steric hindrance. This drawback is overcome by using a “grafting-from” technique, where polymer chain is grown from the surface through a covalently linked monomer or an initiator (see, e.g., (i) Bourgeat-Lami, E. and Lang, J.; J. Coll. Interf. Sci: 1998; Vol. 197; p. 293; (ii) Prucker, O. Rühe; J. Macromolecules; 1998; Vol. 31; p. 602; and (iii) von Werne, T. and Patten, T. E.; J. Am. Chem. Soc.; 1999; Vol. 121; p. 7409). Immobilization of the monomer or initiator units has been challenging in terms of achieving high grafting densities. Usually longer reaction times and a large excess of these monomer or initiator reacting moieties are needed, resulting in less reproducibility and tedious work-up procedures. The other factors that are important in achieving optimal properties for the final hybrid nanomaterials are the molecular weight and polydispersity of the grafted polymer, the chain end of the polymer and the thickness of the brush.

There are a number of reports on the synthesis of such hybrid silica nanoparticle both by “grafting-to” and “grafting-from” techniques. One reported procedure for the “grafting-from” technique is to covalently attach a suitable atom transfer radical polymerization (ATRP) initiator or reversible addition fragmentation transfer (RAFT) agent to silica. Patten and others reported the first synthesis of monosiloxane ATRP initiators and thereafter the ATRP of styrene and methyl methacrylate on nanoparticles (see, e.g., von Werne, T. and Patten, T. E.; J. Am. Chem. Soc.; 1999; Vol. 121; p. 7409). E I Karrack focused on a commercially available mercaptosilane followed by esterification of the thiol groups grafted on the silica surface followed by polymerization (see, e.g., E I Karrak, A., Carrot, G., Oberdisse, J., Eychenne-Baron, C., and Boue, F.; Macromolecules; 2004; Vol. 37; p. 6376). Other methods have involved grafting n-butyl acrylate on silica particles functionalized with an acrylic monomer (see, e.g., (i) Pyun, J., Matyjaszewski, K., Kowalewski, T., Savin, D., Patterson, G., Kickelbick, G., and Huesig, N.; J. Am. Chem. Soc.; 2001; Vol. 123; p 9445; and (ii) Carrot, G., Diamanti, S., Manuszak, M., Charleux, B., and Varion, J. P.; J. Polym. Sci. Part A: Polym Chem.; 2001; Vol. 39; p. 4294). Waller et al. reported the synthesis of novel colloidal polymer/silica composites using complexation (see, e.g., Mori, H., Müller, A. H. E., and Klee, J. E.; J. Am. Chem. Soc.; 2003; Vol. 125; p. 3712).

### SUMMARY OF THE INVENTION

The present invention relates to organic-inorganic hybrid nanomaterials, and to methods for synthesizing same. In one embodiment, the present invention relates to hybrid nanomaterials that comprise an inorganic portion (e.g., inorganic particles such as silica particles) that are coated/covered with one or more polymers compounds (i.e., the organic portion), and to methods for synthesizing such hybrid nanomaterials. In another embodiment, the present invention relates to hybrid nanomaterials that comprise an inorganic portion (e.g., inorganic particles such as silica particles) that have one or more polymers or polymer portions (i.e., the organic portion) grafted and/or attached thereto, and to methods for synthesizing such hybrid nanomaterials.

In one embodiment, the present invention relates to a process for producing surface-modified silica particles comprising the steps of: (A) providing silica particles; (B) subjecting the silica particles to surface functionalization to provide at least one halogen-containing group on the surface of the silica particles thereby yielding halogen-functionalized silica particles; (C) converting the halogen-functionalized silica particles to azide functionalized silica particles; and (D) converting the azide-functionalized silica particles to polymer-functionalized silica particles using click chemistry.

In another embodiment, the present invention relates to a process for producing surface-modified silica particles comprising the steps of: (a) providing silica particles; (b) subjecting the silica particles to surface functionalization to provide at least one halogen-containing group on the surface of the silica particles thereby yielding halogen-functionalized silica particles; (c) reacting the halogen-functionalized silica particles with an atom transfer radical polymerization initiator; and (d) subjecting the reaction product of Step (c) to a click reaction to yield polymer-functionalized silica particles.

In still another, the present invention relates to a process for producing surface-modified silica particles comprising the steps of: (i) providing silica particles; (ii) subjecting the silica particles to an in-situ reaction to attach at least one halogen-containing initiator to the surface thereof to yield initiator-modified silica particles; and (iii) reacting the initiator-modified silica particles via an atom transfer radical polymerization reaction to yield polymer-functionalized silica particles.

### BRIEF DESCRIPTION OF THE DRAWINGS

FIGS. 1(a) and 1(b) are transmission electron microscopy (TEM) photographs of silica nanoparticles with FIG. 1(a) illustrating the absence of BPTS and FIG. 1(b) illustrating the presence of BPTS;

FIGS. 2(a) and 2(b) are photographs illustrating silica particles synthesized using BPTS (20%) as a stabilizer;

FIG. 3 is a graph illustrating the effect of stabilizer addition time on the size of the particles of a nanomaterial;

FIG. 4 is a graph illustrating the FT-IR spectra of an initiator coated and polymerized coated silica particles; and

FIG. 5 is a graph illustrating thermogravimetric analysis (TGA) of various aspects of the present invention.

### DETAILED DESCRIPTION OF THE INVENTION

The present invention relates to organic-inorganic hybrid nanomaterials, and to methods for synthesizing same. In one embodiment, the present invention relates to hybrid nanomaterials that comprise an inorganic portion (e.g., inorganic particles such as silica particles) that are coated/covered with one or more polymers compounds (i.e., the organic portion), and to methods for synthesizing such hybrid nanomaterials. In another embodiment, the present invention relates to hybrid nanomaterials that comprise an inorganic portion (e.g., inorganic particles such as silica particles) that have one or more polymers or polymer portions (i.e., the organic portion) grafted and/or attached thereto, and to methods for synthesizing such hybrid nanomaterials.

Synthesis of silica is a heterogeneous condensation polymerization and the particles are stabilized by “electrostatic stabilization” by the charges formed in situ on the surface during the reaction. An alternative to electrostatic stabilization is steric stabilization where specific non-reactive molecules, widely known as stabilizers, are added during condensation polymerization, adsorb to the surface of silica particles, and thus prevent coagulation. A variant of steric stabilizers is a reactive stabilizer that will participate in the condensation reaction in addition to functioning as a stabilizing group. These stabilizing groups can be a monomer, initiator or a polymer. The disadvantages of coagulation or lower grafting densities one faces while modifying preformed nanoparticles can be easily overcome by nanosilica synthesis in the presence of reactive stabilizers.

In one embodiment, the process of the present invention involves the in situ formation of functionalized silica nanoparticles. The reactive stabilizer used in one embodiment of the present invention has an ATRP initiator at the non-condensable end yielding an initiator immobilized silica nanoparticle. The present invention is not limited to just one reactive stabilizer. Instead, any reactive stabilizer that is suitable for use in conjunction with the in situ formation of functionalized silica nanoparticles, as described herein, can be used in the present invention. The initiator immobilized silica nanoparticles are then used for polymerization and block copolymerization of styrene, tert-butyl acrylate and methyl acrylate. This unique process results in the formation of particles with a size range of about 2 nm to about 500 nm, or about 5 nm to about 400 nm, or about 7 nm to about 300 nm. Here, as well as elsewhere in the specification and claims, individual range limits can be combined to form additional non-disclosed ranges.

The size of particles formed in accordance with the present invention depends on a number of factors including, but not limited to, the stabilizer concentration, the type of stabilizer, and the synthesis process.

In addition, the present invention also describes the use of “click” chemistry to modify silica nanoparticles. Sharpless et al. first described the synthetic utility of a 1,3-dipolar cycloaddition of azides and terminal alkynes, catalyzed by copper(I), in organic synthesis (see, e.g., Rostovtsev, V. V., Green, L. G., Fokin, V. V., and Sharpless, K. B.; Angew. Chem. Int. Ed. End.; 2002; Vol. 41; p. 2596). These reactions have very high thermodynamic driving force which makes them one of the most efficient reactions available. Due to their efficiency and simplicity, these cycloadditions are classified as “click” reactions. These reactions have high specificity, quantitative yields, and near-perfect fidelity in the presence of most functional groups.

Combining the chain-end functionality control of living free radical polymerization and the efficiency of “click” chemistry is an interesting pathway for the surface modification of silica nanoparticle. In another embodiment, the present invention also relates to the synthesis of alkyne terminated functional polymers using atom transfer radical polymerization (ATRP) and reverse addition fragmentation technique (RAFT) polymerization which can be combined with “click” chemistry providing the substrate possesses an azide group. In one instance, the present invention utilizes a “click” coupling reaction to attach a polymer prepared by living radical polymerization (ATRP & RAFT) onto the surface of silica nanoparticle.

The scope of the chemistry described herein can be extended to all vinyl monomers that are used in radical polymerization, and as such, the present invention is not to be limited to any one vinyl monomer, or even to any one type of vinyl monomer. Furthermore, in some embodiments of the present invention, surface-imbedded groups can be used for certain forms of condensation polymerization; in particular, the formation of polyurethanes and epoxy materials. The condensation method for functionalized silica particles can include the following types of groups: (1) initiators for ATRP; (2) chain transfer groups (e.g., thiols); (3) initiator groups for conventional radical polymerization (e.g., peroxides or azo compounds); (4) epoxide groups that can participate in ring-opening polymerization often used for epoxy and urethane compositions; and (5) dithioesters that can participate in RAFT. In general, the condensation method of the present invention is very versatile and can be used for a number of polymerization processes.

The scope of the present invention further includes the combination of RAFT and “click” chemistry. Any nanoparticle that can be functionalized with an azide group is covered by this portion of the present invention. Although the present invention utilizes silica as a nanoparticle, the present invention is not limited thereto. The scope of polymer modifiers disclosed herein are intended to apply to any material that can made with alkyne functional group. Herein, the method of the present invention is demonstrated using a polyacrylamide, but the method of the present invention can be applied to any vinyl monomer that is capable of undergoing a radical polymerization.

### Experimental:

Materials: Styrene, methyl acrylate, tert-butyl acrylate (all available from Aldrich, all 98%) are passed through a column of activated basic alumina prior to use. CuBr (available from Aldrich, 98%) is purified as described in literature (see, e.g., Keller, R. N., and Wycoff, H. D.; Inorg. Synth., 1947, 2, p. 1). N,N,N′,N′,N′-pentamethyldiethylenetriamine (PMDETA, 99%), ethyl 2-bromoisobutyrate (E2Br-iB, 98%), anhydrous anisole (99.8%), toluene (99.8%), tetraethyoxysilane (TEOS) (99%), ammonia (28% aqueous solution) are used as received (all available from Aldrich).

(3-(2-Bromoisobutyryl)propyl) Triethoxysilane (BPTS) and (3-(2-Bromoisobutyryl)propyl) Ethoxydimethylsilane (BPMS): BPTS and BPMS are synthesized via a two step reaction (see Scheme 1 below).

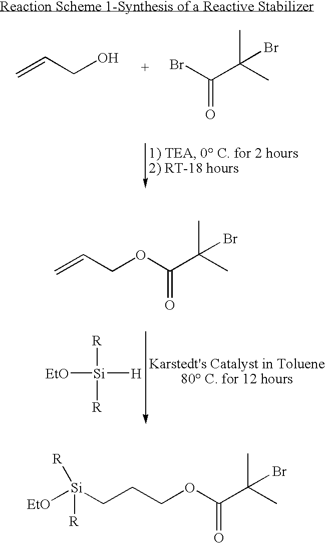

In the above reaction each R is either ethoxy (EtO) or methyl. In the case where R is ethoxy the compound produced via the above Reaction Scheme is 3-(2-bromoisobutyryl)propyl) triethoxysilane (BPTS) and where each R is a methyl group the compound produced via the above Reaction Scheme is (3-(2-bromoisobutyryl)propyl)ethoxydimethylsilane (BPMS). Although the above reaction, and subsequent reactions herein, are shown with bromine-containing compounds the present invention is not limited thereto. Rather, other halogens can be used in place of, or in addition to, the bromine compounds disclosed herein.

The first step involves the drop-wise addition of 2-bromoisobutyryl bromide, (20 mL, 158.2 mmol) to a cold solution of allyl alcohol (7.08 mL, 104.2 mmol) in dry THF (500 mL) with triethylamine (14.6 mL, 104.2 mmol) at 0° C. After complete addition, the temperature of the mixture is allowed to rise and the mixture is left stirring overnight (18 hours) at room temperature. After completion of reaction, the salts are removed by filtration and the volatiles are removed in vacuo. The residue is diluted with dichloromethane (500 mL) and sequentially washed twice with 1 N HCl aqueous solution (2×250 mL), twice with saturated NaHCO₃ aqueous solution (2×250 mL) and with water (500 mL). The organic layer is dried over anhydrous MgSO₄ and evaporated to give a yellow oil, which is purified by distillation at 50° C. under vacuum to yield allyl 2-bromoisobutyrate (ABI) as a colorless liquid (the yield is 90%).

The second step involves the silylation of allyl 2-bromoisobutyrate. ABI (10.6 grams, 50 mmol), and triethoxysilane or dimethylethoxysilane (65 mmol) are charged into a two neck flask equipped with a magnetic stir bar, reflux condenser and nitrogen inlet. The flask is heated to 80° C. and subsequently a Karsted's catalyst solution (2×10⁻² mL, 2.5×10⁻² mmol) is added. The reaction is monitored by ¹H NMR for disappearance of double bond indicating completion of silylation. Unreacted silane is removed by vacuum distillation at 60° C., to yield BPTS or BMPS as a yellow oily liquid (the yield is 85%).

Initiator Coated Silica Particles: Initiator coated silica nanoparticles are synthesized by the hydrolytic condensation of TEOS in the presence of BPTS or BMPS as the reactive stabilizer. (see Reaction Scheme 2 below).

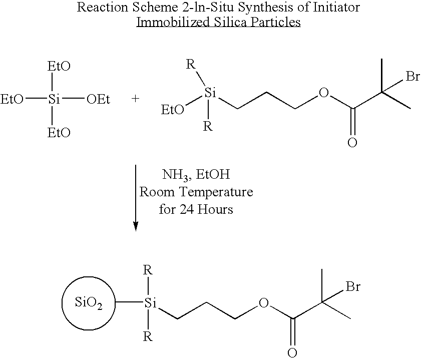

In the above reaction, although the silica particle is shown with one initiator “tail” it should be appreciated that the silica nanoparticles produced via Reaction Scheme 2 can have two or more initiator “tails”.

Initially, TEOS (3 mL) is added to a 50 mL solution of ethanol. Next, either an acidic catalyst or basic catalyst is added. The initiator (w/w relative to TEOS) to be immobilized is added at varying time intervals. The reaction is allowed to proceed at ambient temperature for 24 hours. After completion of the reaction, the particles are isolated by centrifugation from the reaction mixture. The particles are repeatedly washed with tetrahydrofuran (THF) (2 washings), ethanol and water to remove the catalyst and unreacted initiator. The silica particles are dried overnight in a vacuum oven at 60° C.

Polymerization: An initiator coated silica particle (1 gram) is added to a 100 mL Schlenk flask. The flask is degassed and back-filled with nitrogen three times and left under nitrogen. CuBr (0.037 grams, 0.25 mmol), anisole (7 mL), and monomer (7 ml) are added to a separate 100 mL Schlenk flask along with a magnetic stirrer bar and sealed with a rubber septum. Three cycles of free pump-thaw process are performed. PMDETA (0.1 mL, 0.48 mmol) is added to the mixture via syringe and the solution becomes homogenous. The solution is then transferred to the flask containing the silica nanoparticles via a cannula, followed by the addition of the free initiator (E2Br-iB) (0.022 mL, 0.15 mmol) via a syringe. The polymerization is allowed to proceed at different times and temperatures depending on the monomer. To remove free polymer, the polymerized solution is repeatedly sonicated and centrifuged in THF. The silica particles are dried overnight in a vacuum oven at 70° C.

Instrumentation: Gel permeation chromatography (GPC) analysis is carried out using a Waters 501 pump, a guard column, Waters HR2 and HR4 Styragel columns, a Waters 410 differential refractometer, and a Viscotek T60A dual detector. The eluent is THF, and the flow rate is 1.0 mL/min. Mₙ and M_{w} are determined using universal calibration. The bromine content of the initiator coated silica particle is determined by elemental analysis (Galbraith Laboratories). FT-1R data is recorded on a Digilab, Excalibur 300 series instrument using KBr pellets. Thermogravimetric analysis (TGA) is performed in nitrogen atmosphere on a Hi-Res TGA 2950 thermogravimetric analyzer (TA instruments) over the temperature range 23-800° C. at a heating rate of 10° C./min. Transmission electron microscopy (TEM) is performed using a FEI Techani 12; samples are prepared on a carbon coated copper grid. X-ray photoelectron spectroscopy (XPS) is performed on a Perkin-Elmer instrument using Al Kα radiation at the MATNET Surface Analysis Center at Case Western Reserve University with a take-off angle of 45°.

### Results and Discussion:

Initiator Coated Silica Nanoparticles:

Effect of pH:

Silica nanoparticles are synthesized by sol-gel technique and by condensation technique using alkoxysilanes. In the sol-gel process, silicic acid is polymerized to form primary particles, which subsequently aggregate to form larger particles. In the condensation technique, silica particles are formed by the simultaneous hydrolysis and condensation of sodium silicates or alkoxysilanes. Complete hydrolysis is achieved in the presence of an acid or base catalyst. As condensation proceeds, small three-dimensional siloxane networks are gradually formed. Stöber et al. has reported the controlled synthesis of spherical silica particle by hydrolytic condensations of tetraethoxysilane using ammonia as a catalyst (see, Stöber et al.; Coll. Interf. Sci.; 1968; Vol. 26; p. 62). The condensation reaction is influenced by the type of the alkoxysilane, presence of an electrolyte and pH. Ying et al. studied the effect of pH and found that under acidic conditions, the rate of hydrolysis is faster which slows down with increasing siloxane linkages (see, Ying et al.; J. Am. Ceram. Soc.; 1993; Vol. 76, p. 2571). This leads to weakly branched polymeric networks. Whereas, in basic condition the condensation process is accelerated relative to hydrolysis, resulting in an increased condensation with an increasing number of siloxane linkages. In one embodiment, this produces a highly branched network structure accompanied by, at a minimum, ring structures. Herein, both basic and acidic catalysts are used to study the effect of a stabilizer on the nanoparticle synthesis. Acidic catalysts are found to produce lower yields as well as transparent particles, whereas basic catalysts are found to produce higher yields and opaque particles. This confirms that basic catalysis produces larger particles with a higher degree of crosslinking.

Effect of Stabilizer Concentration and Addition:

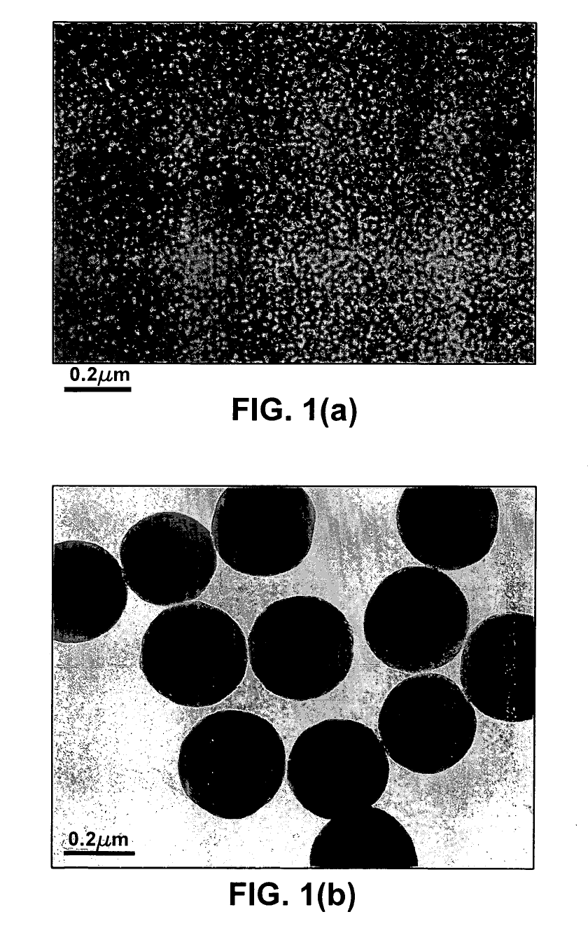

Silica nanoparticles are synthesized in the presence and absence of stabilizer to evaluate the relationship between stabilizer and particle size. It is predicted that particle growth would be prevented by decreased condensation due to lower TEOS concentrations. As predicted, the addition of BPTS results in a marked difference in the size of particles. The size of particle in the absence of BPTS is approximately 350 nm. However the size decreases to about 7 nm to about 10 nm in the presence of BPTS, This confirms the role of BPTS as a stabilizer in the silica nanoparticle formation, which prevented coagulation (see FIG. 1). This is attributed to the steric stabilization effect. Normally, the stability of the growing particle is controlled by charged ions on the surface (electrostatic stabilization). However, in the presence of BPTS, which has reactive groups, the polar groups form a protective shell and prevent coagulation due to a stabilizer effect. Both BPTS and BPMS show similar trends.

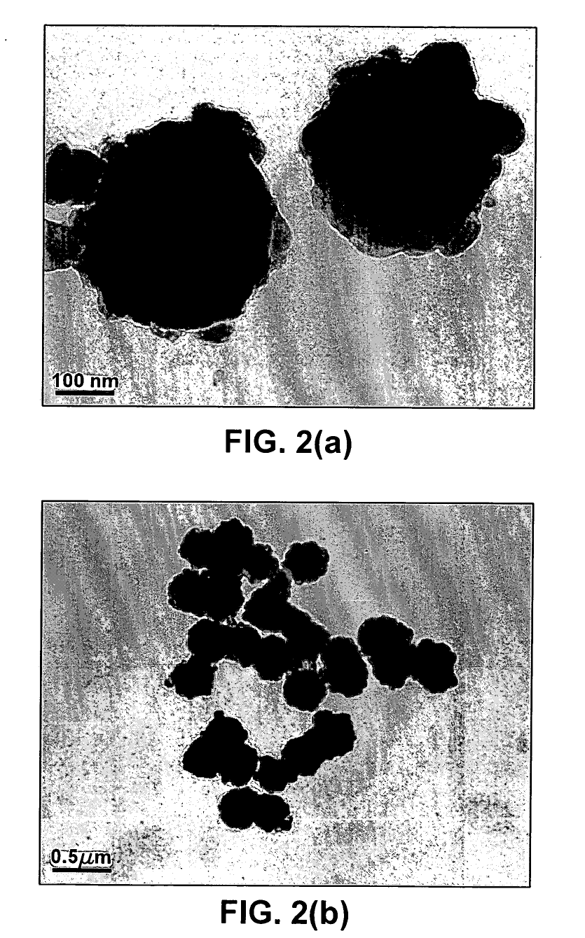

The stabilizer effect on silica particle synthesis can also be seen by varying the stabilizer concentration under similar reaction conditions, with respect to TEOS. As the BPTS concentration increases, a decrease in particle size is observed. This result is explained by particle stabilization and the decreased growth of the particle (due to the lack of propagating groups on the surface). While not wishing to be bound to any one theory, it is believed that because BPTS contains three condensable groups, not all of the condensable groups are reacting in a single particle. This results in a “raspberry-like” structure, as is shown in FIG. 2. However, this structure disappears and a core shell structure results upon using BPMS, which has only one condensable group. Tabulated below is the study on the effect of concentration of the stabilizers on size of particle under similar reaction conditions (see Table 1).

TABLE 1
Effect of Stabilizer Concentration on
Particle Size (Time of Addition = 1 Hour)

Stabilizers (nm)

| Concentration (%) | BPTS^{a} | BPMS^{b} |
|---|---|---|
| 0 | 350 | 350 |
| 1 | 200 | 300 |
| 2 | 180 | 280 |
| 10 | 160 | 200 |
| 15 | 150 | 160 |
| 20 | 150 | 150 |

^{a}BPTS = (3-(2-bromoisobutyryl)propyl) triethoxysilane; and
^{b}BPMS = (3-(2-bromoisobutyryl)propyl) ethoxydimethylsilane.

Effect of Stabilizer Addition Time:

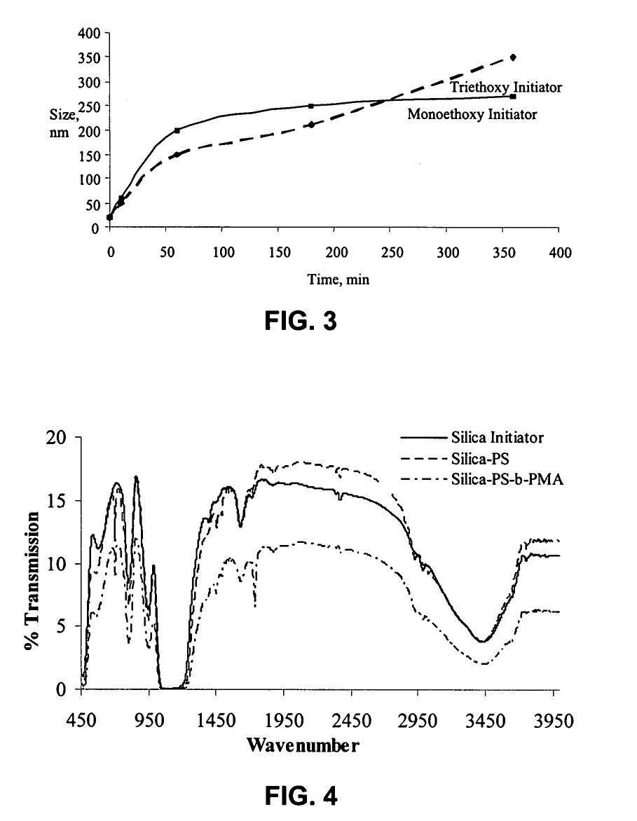

Another parameter that has an impact on particle size is the time of stabilizer addition. For instance, the present invention makes it possible to control particle size based on the time of stabilizer addition. Smaller particles are formed with early stabilizer addition due to the reactive end of the BPTS stabilizer that hinders particle growth (see FIG. 3). Both stabilizers show a similar trend.

In another embodiment, the stabilizer of the present invention can also perform a second role, that of an initiator (i.e., a reactive stabilizer). In still another embodiment, the methods of the present invention utilize one or more compounds that act as an initiator(s) and one or more compounds that act as a stabilizer(s). In this embodiment, particle size can be impacted by a variety of parameters including the concentration, addition of, and/or the addition time of either one, or both, of a stabilizer and/or initiator compound(s).

Characterization of Silica Particles:

The uncoated and coated silica particles are characterized by ²⁹Si NMR, FT-IR, TGA (to determine weight loss) and elemental analysis (to determine the bromine content). FT-IR analysis shows the characteristic carbonyl stretching of ester group of the initiating moiety at 1730 cm⁻¹ (see FIG. 4).

Polymerization:

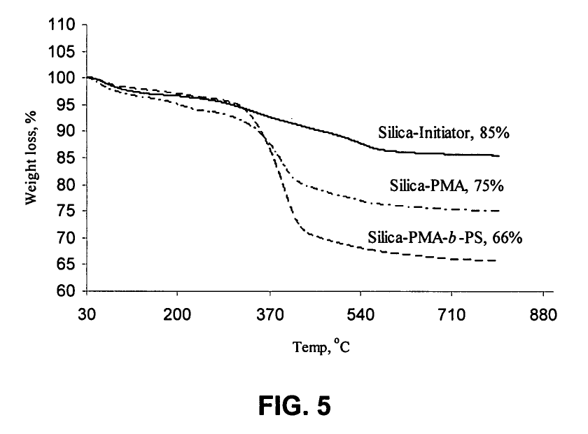

The initiator immobilized silica particles are used for ATRP of MA, styrene and tert-BuA. The results are tabulated below (see Table 2). The controlled nature of the polymerization is confirmed by synthesizing block copolymers. The grafted polymer chains are cleaved from the silica surface with HF. This free polymer is used to determine the molecular weight and polydispersity index. Thermogravimetric analysis confirmed the presence of polymer on the surface of the silica surface (see FIG. 5).

TABLE 2
Synthesis of Diblock Polymer Particles
from Initiator Immobilized Silica Particles

| | GPC | | TGA (Final |
|---|---|---|---|
| | Mₙ g/mol (free | | Weight |
| Sample | polymer) | PDI | Loss, %) |
| Silica-PS-b-PMA | PS 7000 | 1.3 | 24 |
| | PMA 6200 | 1.3 | |
| Silica-PS-b-P(tert-BuA) | PS 10000 | 1.2 | 28 |
| | P(tert-BuA) 16000 | 1.3 | |
| Silica-PMA-b-PS | PMA 10100 | 1.1 | 34 |
| | PS 27000 | 1.2 | |
| Silica-PMA-b-P(tert- | PMA 11000 | 1.1 | 27 |
| BuA) | P(tert-BuA) 17600 | 1.1 | |
| Silica-P(tert-BuA)-b- | P(tert-BuA) 13000 | 1.3 | 23 |
| PMA | PMA 12000 | 1.2 | |
| Silica-P(tert-BuA)-b-PS | P(tert-BuA) 13000 | 1.3 | 24 |
| | PS 10000 | 1.2 | |

Modification of Silica Nanoparticles Using Click Chemistry and RAFT Polymerization:

Synthesis of Alkyne Terminated Polymer:

Carboxyl terminated RAFT agent is synthesized using a previously reported procedure (see, Lai, J. T., Filla, D., and Shea, R.; Macromolecules; 2002; Vol. 35; p. 6754). The carboxyl terminated RAFT agent is converted into an alkyne terminated RAFT agent using an esterification reaction. This functionalized RAFT agent is used to polymerize acrylamide to produce a functionalized polyacrylamide with Mₙ=5,000 g/mol (see Reaction Scheme 3 below). The present invention is not limited to only the above functionalized polyacrylamide with an Mₙ of 5,000. Rather, the present invention can be broadly applied to produce functionalized polyacrylamides having a wide range of Mₙ values.

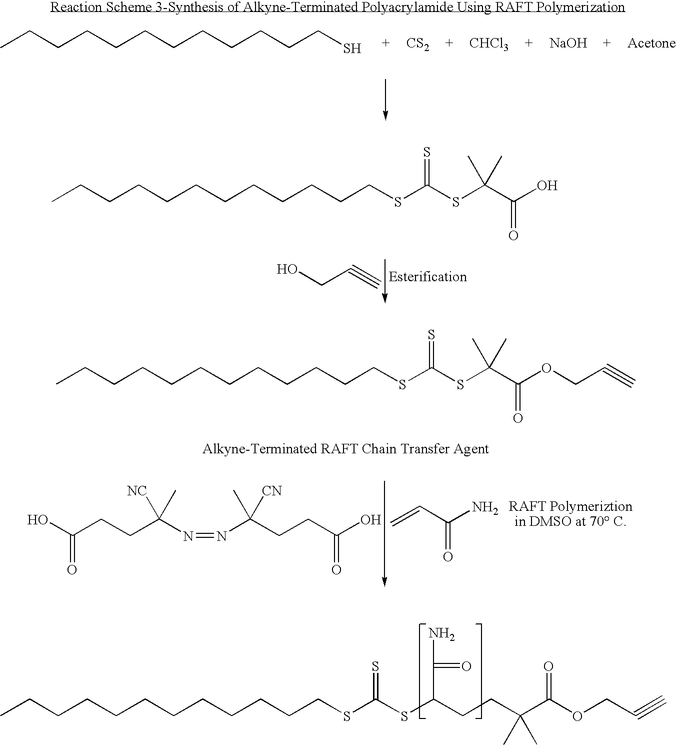

Modification of Silica Nanoparticles:

A two step synthetic route is used to modify the surface of silica nanoparticle with an azide functionality (see, e.g., Lummerstorfer, T and Hoffmann, H.; Phys. Chem. B; 2004; Vol. 108(13); p. 3963). In the first step, 3-bromopropyl trichlorosilane is immobilized on silica nanoparticles to generate a bromine group on the surface. These silica particles are subsequently reacted with sodium azide to convert bromine group into azide group. These azide modified silica particles are reacted with the alkyne terminated polyacrylamide via “click” chemistry (see Reaction Scheme 4 below). This surface modification of silica particles corresponds to a “grafting to” approach. The modification of silica particles are characterized using IR, TGA and elemental analysis at each step.

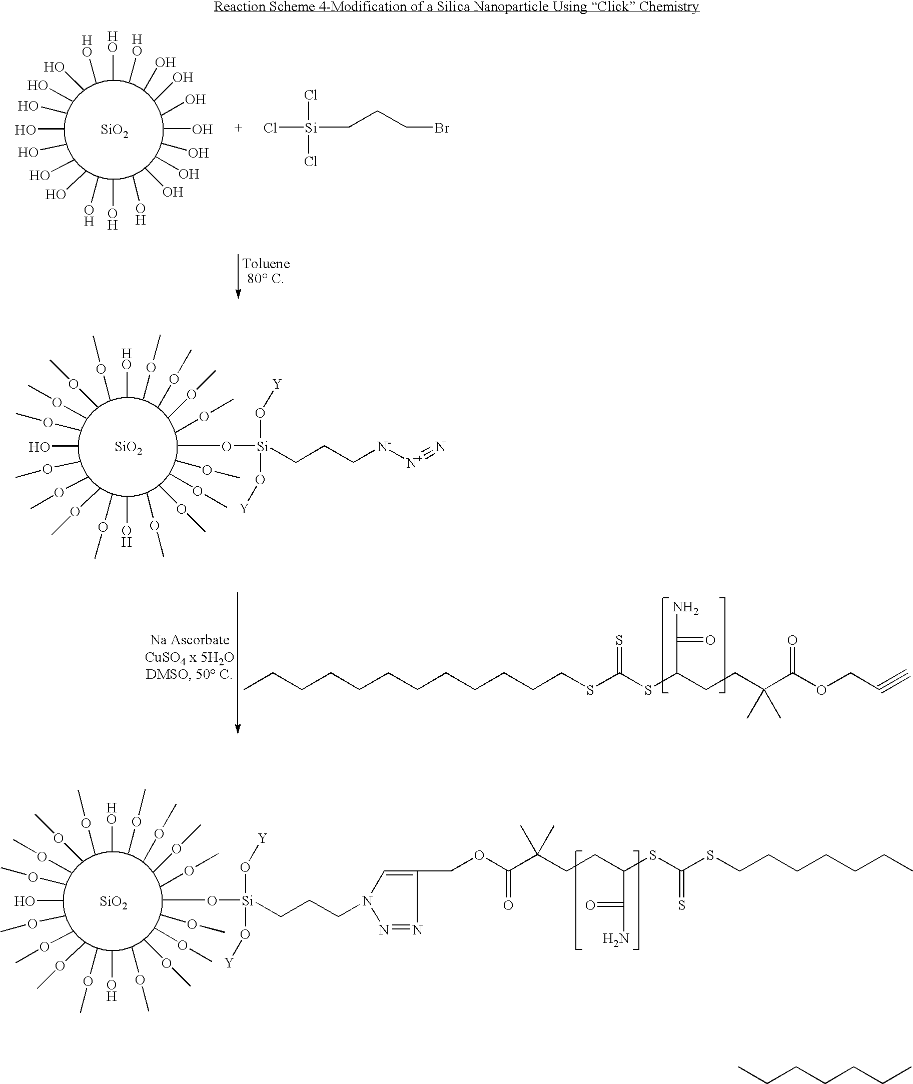

In the above reaction, Y is selected from H or Si. Additionally, although the silica particle is shown with one functionalization it should be appreciated that the silica nanoparticles can have two or more functionalizations as is denoted by the OH groups that are shown as —O— linkages off the silica nanoparticle in Reaction Scheme 4.

Modification of Silica Nanoparticles using “Click” Chemistry and ATRP:

The present invention is extended our work to ATRP. Alkyne terminated ATRP initiator is synthesized using a two step process. This initiator is used to perform ATRP in the preparation of an alkyne terminated polystyrene with Mₙ=10,000 g/mol (see Reaction Scheme 5). The alkyne terminated polystyrene is reacted with an azide modified silica nanoparticle via “click” chemistry to obtain a polystyrene grafted silica nanoparticle.

In the reaction below, Y is selected from H or Si. Additionally, although the particles are shown with one functionalization, the silica nanoparticles can have two or more functionalizations as is denoted by the —OH groups that are shown as —O— linkages off the silica nanoparticle in the Reaction Scheme below.

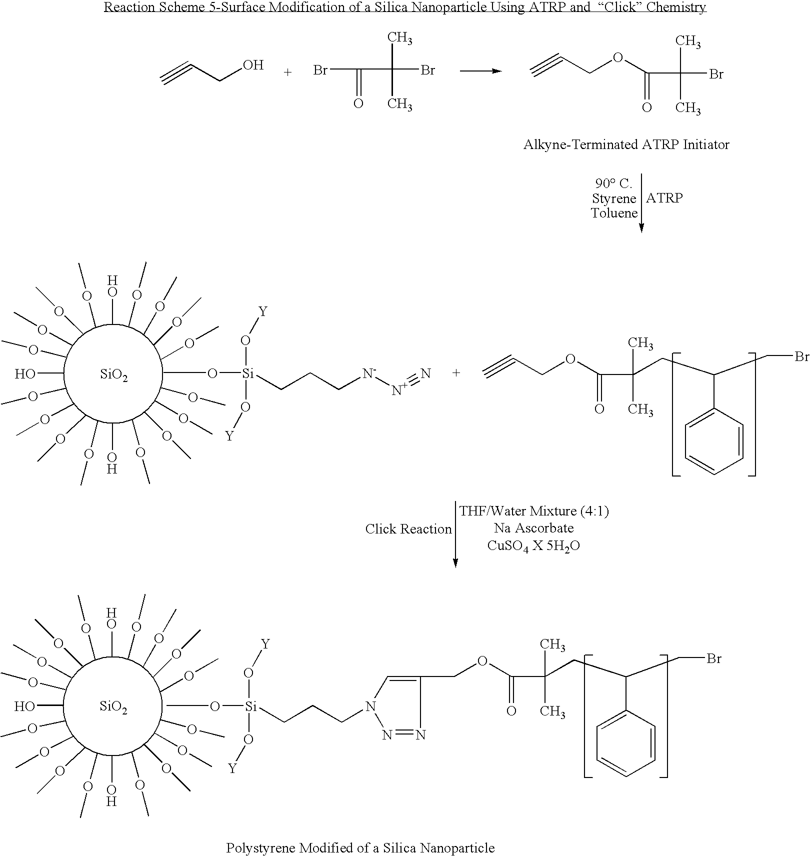

Additionally, although the silica particle is shown with one “surface modification” it should be appreciated that the silica nanoparticles can have two or more “surface modification” as is denoted by the —OH groups that are shown as —O— linkages off the silica nanoparticle in Reaction Scheme 5.

Silica particles coated with block copolymers are successfully synthesized using in situ condensation method. While not wishing to be bound to any one aspect, the present invention is advantageous in that it utilizes a one step condensation process to achieve initiator coated silica particles resulting in a core shell particle, with silica comprising the core and the initiator or other functional group comprising the shell. In accordance with the present invention, any type of polymerization initiator can be attached onto the silica surface. Any functional group that will not interfere with condensation chemistry can be used to form the shell. The chemical composition of the shell can easily be transformed into a polymer outer layer.

In another embodiment, the present invention relates to the use of a preformed polymer as the stabilizer. This yields silica particles directly coated with a polymer. The size of the particles can be controlled by varying the time of addition of the initiator and the concentration of the initiator. Silica particles having a size in the range of about 10 nm to about 300 nm are synthesized in view of the methods contained herein.

In another embodiment, the present invention further includes methods that utilize “click” chemistry to attach one or more polymers to a nanoparticle. In one instance, the nanoparticle is first modified to prepare an azide functionalized surface. In a separate process, alkyne terminated polymers are prepared using living radical polymerization techniques (exemplified here are polymers prepared using RAFT and ATRP). In light of the disclosure contained herein, it is demonstrated that an alkyne terminated polymer readily reacts with an azide modified nanoparticle to produce a polymer modified surface.

The present invention is not limited to the use of just the functionalizing polymers disclosed herein. Rather, any suitable polymer compound can be used to functionalize silica particles in accordance with the various methods disclosed herein. Some suitable polymers that can be used in conjunction with the present invention include, but are not limited to, one or more polyacrylamide polymers, one or more polystyrene polymers, one or more polyethylene polymers, one or more polypropylene polymers, one or more polybutylene polymers, one or more polyacrylate polymers, one or more polymethacrylate polymers, or a suitable combination of two or more thereof. As used herein, the term polymer is to be broadly construed and includes, for example, polymers, copolymers, block copolymers, terpolymers, etc.

Although the invention has been described in detail with particular reference to certain embodiments detailed herein, other embodiments can achieve the same results. Variations and modifications of the present invention will be obvious to those skilled in the art, and the present invention is intended to cover in the appended claims all such modifications and equivalents.

What is claimed is:

1. A process for producing surface-modified silica particles comprising the steps of:
(A) providing silica particles;
(B) subjecting the silica particles to surface functionalization to provide at least one halogen-containing group on the surface of the silica particles thereby yielding halogen-functionalized silica particles;
(C) converting the halogen-functionalized silica particles to azide-functionalized silica particles; and
(D) converting the azide-functionalized silica particles to polymer-functionalized silica particles using click chemistry.

2. The process of claim 1, wherein the silica particles are functionalized with one or more polyacrylamide polymers, one or more polystyrene polymers, one or more polyethylene polymers, one or more polypropylene polymers, one or more polybutylene polymers, one or more polyacrylate polymers, one or more polymethacrylate polymers, or a suitable combination of two or more thereof.

3. The process of claim 2, wherein the silica particles are functionalized with one or more polyacrylamide polymers.

4. The process of claim 2, wherein the silica particles are functionalized with one or more polystyrene polymers.

5. The process of claim 1, wherein the silica particles are nanoparticles.

6. The process of claim 5, wherein the silica nanoparticles have an average size of about 2 nm to about 500 nm.

7. The process of claim 5, wherein the silica nanoparticles have an average size of about 5 nm to about 400 nm.

8. The process of claim 5, wherein the silica nanoparticles have an average size of about 7 nm to about 300 nm.

9. The process of claim 1, wherein the halogen-containing group is a bromine-containing group.

10. A surface-modified silica nanoparticle product formed by the process of claim 1.

11. A process for producing surface-modified silica particles comprising the steps of:
(a) providing silica particles;
(b) subjecting the silica particles to surface functionalization to provide at least one halogen-containing group on the surface of the silica particles thereby yielding halogen-functionalized silica particles;
(c) reacting the halogen-functionalized silica particles with an atom transfer radical polymerization initiator, and
(d) subjecting the reaction product of Step (c) to a click reaction to yield polymer-functionalized silica particles.

12. The process of claim 11, wherein the silica particles are functionalized with one or more polyacrylamide polymers, one or more polystyrene polymers, one or more polyethylene polymers, one or more polypropylene polymers, one or more polybutylene polymers, one or more polyacrylate polymers, one or more polymethacrylate polymers, or a suitable combination of two or more thereof.

13. The process of claim 12, wherein the silica particles are functionalized with one or more polyacrylamide polymers.

14. The process of claim 12, wherein the silica particles are functionalized with one or more polystyrene polymers.

15. The process of claim 11, wherein the silica particles are nanoparticles.

16. The process of claim 15, wherein the silica nanoparticles have an average size of about 2 nm to about 500 nm.

17. The process of claim 15, wherein the silica nanoparticles have an average size of about 5 nm to about 400 nm.

18. The process of claim 15, wherein the silica nanoparticles have an average size of about 7 nm to about 300 nm.

19. The process of claim 11, wherein the halogen-containing group is a bromine-containing group.

20. The process of claim 11, wherein the atom transfer radical polymerization initiator of Step (c) is an alkyne-terminated initiator.

21. A surface-modified silica nanoparticle product formed by the process of claim 11.

22. A process for producing surface-modified silica particles comprising the steps of:
(i) providing silica particles;
(ii) subjecting the silica particles to an in-situ reaction to attach at least one halogen-containing initiator to the surface thereof to yield initiator-modified silica particles; and
(iii) reacting the initiator-modified silica particles via an atom transfer radical polymerization reaction to yield polymer-functionalized silica particles.

23. The process of claim 22, wherein the silica particles are functionalized with one or more polyacrylamide polymers, one or more polystyrene polymers, one or more polyethylene polymers, one or more polypropylene polymers, one or more polybutylene polymers, one or more polyacrylate polymers, one or more polymethacrylate polymers, or a suitable combination of two or more thereof.

24. The process of claim 23, wherein the silica particles are functionalized with one or more polyacrylamide polymers.

25. The process of claim 24, wherein the silica particles are functionalized with one or more polystyrene polymers.

26. The process of claim 22, wherein the silica particles are nanoparticles.

27. The process of claim 26, wherein the silica nanoparticles have an average size of about 2 nm to about 500 nm.

28. The process of claim 26, wherein the silica nanoparticles have an average size of about 5 nm to about 400 nm.

29. The process of claim 26, wherein the silica nanoparticles have an average size of about 7 nm to about 300 nm.

30. The process of claim 11, wherein the halogen-containing group is a bromine-containing group.

31. A surface-modified silica nanoparticle product formed by the process of claim 22.
